(19) United States
(12) Patent Application Publication
(10) Pub. No.: US 2020/0030921 A1
(43) Pub. Date: Jan. 30, 2020

(54) ALLOYS

(71) Applicant: UMICORE AG & CO. KG, Hanau-Wolfgang (DE)

(72) Inventors: Gunther WIEHL, Jena (DE); Frank SILZE, Triebischtal (DE); Bernd KEMPF, Kleinwallstadt (DE)

(73) Assignee: UMICORE AG & CO. KG

(21) Appl. No.: 16/592,504

(22) Filed: Oct. 3, 2019

Related U.S. Application Data
(62) Division of application No. 14/345,646, filed on Mar. 18, 2014.

(30) Foreign Application Priority Data
Jan. 18, 2013 (EP) 13151874.8

(51) Int. Cl. B23K 35/30; B21B 1/22; B23K 1/00; C22C 5/08; C22C 9/00; C22C 30/02

(52) U.S. Cl. CPC B23K 35/302; B23K 35/3006; B23K 35/30; C22C 30/02; B23K 1/00; C22C 5/08; C22C 9/00; B21B 1/22

(57) ABSTRACT

Novel alloys which can be employed in joining technology and have improved wetting properties are described.

The soldering of metal parts, e.g. steel parts, copper and copper alloys, nickel and nickel alloys, brass alloys or metalized ceramics, using nonferrous solder is known. Typical solders encompass silver, gold, nickel and copper solders. Silver solders are more expensive and generally melt at lower temperatures than copper alloys.

Despite the widespread use of silver solders, there is still a need for an alloy which, for example, displays improved soldering properties on steel substrates and reduces the silver content required.

Silver soft solder alloys or silver hard solder alloys with manganese and/or nickel and having a copper content are, for example, described in JP 57-149022, JP 57-149093 or in U.S. Pat. No. 2,303,272.

Furthermore, soldering of steel or of free steel alloys is usually carried out using the known solder alloys “Braze 580” and “Braze 655”, based on silver with participation of Cu and Mn or additionally containing nickel (Braze 655). Accordingly, it would be desirable to provide a silver solder alloy having improved wettability.

It was an object of the invention to provide a novel, essentially zinc-free (and thus useable for vacuum applications) solder alloy which displays a high cold deformability, good wetting of stainless steel and structural steels and a working temperature of from 750° C. to 900° C.

This object is achieved by a solder alloy containing from 20% by weight to 44% by weight of silver, from 5% by weight to 15% by weight of gallium and copper as balance to 100% by weight, where the constituents can contain unavoidable impurities.

### BRIEF DESCRIPTION OF THE INVENTION

1. Solder alloys containing from 41% by weight to 75% by weight of copper, from 20% by weight to 44% by weight of silver and from 5% by weight to 15% by weight of gallium, where the constituents add up to 100% by weight and can contain unavoidable impurities.
2. Solder alloy as per point 1, where the content of zinc must not exceed 0.01% by weight.
3. Solder alloys as per point 1 or 2, consisting of from 41% by weight to 75% by weight of copper, from 20% by weight to 44% by weight of silver, from 5% by weight to 15% by weight of gallium and from 0 to 15% by weight of further alloy constituents selected from the group consisting of indium, tin, germanium, titanium, manganese, silicon, nickel and combinations thereof, where the constituents add up to 100% by weight and can contain unavoidable impurities and the content of zinc must not exceed 0.01% by weight.
4. Solder alloys as per point 1, 2 or 3, containing from 25 to 44% by weight or from 30 to 44% by weight of silver.
5. Solder alloys as per point 1, 2, 3 or 4, containing from 45 to 60% by weight of copper.
6. Solder alloys as per point 1, 2, 3, 4 or 5, containing from 6% by weight to 14% by weight of gallium.
7. Solder alloys as per one or more of the preceding points, containing from 20% by weight to 44% by weight of silver and from 5% by weight to 15% by weight of gallium, from 0.1% by weight to 15% by weight (or from 0.1% by weight to 10% by weight) of further alloying elements, selected from the group consisting of indium, tin, germanium, titanium, manganese, silicon, nickel and combinations thereof and copper as balance to 100% by weight, wherein the constituents add up to 100% by weight and can contain unavoidable impurities.
8. Solder alloys as per point 5, wherein indium is present in combination with tin, titanium or manganese as further element.
9. Solder alloy as per one or more of the preceding points, consisting of from 48% by weight to 67% by weight of copper, from 20% by weight to 25% by weight of silver, from 5 to 15% by weight of gallium, from 0% by weight to 15% by weight of manganese, from 0% by weight to 3% by weight of indium, wherein the content of manganese is greater than 10% by weight when the gallium content is less than 10% by weight and the amounts add up to 100% by weight.
10. Solder alloy as per one or more of points 1 to 8 consisting of from 58% by weight to 65% by weight of copper, from 20% by weight to 25% by weight of silver, from 5 to 15% by weight of gallium, from 0% by weight to 15% by weight of manganese, from 0% by weight to 3% by weight of indium, wherein the content of manganese is greater than 10% by weight when the gallium content is less than 10% by weight and the amounts add up to 100% by weight.
11. Solder alloy as per point 9 or 10, wherein the content of gallium is greater than 10% by weight, when the manganese content is less than 10% by weight.
12. Solder alloy as per one or more of points 1 to 8 consisting of from 41% by weight to 54% by weight of copper, from 38% by weight to 42% by weight of silver, from 8 to 12% by weight of gallium, from 0% by weight to 5% by weight of manganese, from 0% by weight to 4% by weight of indium, where the amounts add up to 100% by weight.
13. Solder alloy as per one or more of points 1 to 8 consisting of from 41% by weight to 52% by weight of copper, from 38% by weight to 42% by weight of silver, from 5 to 9% by weight of gallium, from 7% by weight to 12% by weight of manganese, from 0% by weight to 4% by weight of indium, where the amounts add up to 100% by weight.
14. Solder alloy as per one or more of points 1 to 8 consisting of from 50% by weight to 64% by weight of copper, from 28% by weight to 34% by weight of silver, from 8 to 12% by weight of gallium, from 0% by weight to 5% by weight of manganese, from 0% by weight to 4% by weight of indium, where the amounts add up to 100% by weight.
15. Solder alloy as per one or more of points 1 to 8 consisting of from 45% by weight to 62% by weight of copper, from 28% by weight to 34% by weight of silver, from 5 to 9% by weight of gallium, from 7% by weight to 12% by weight of manganese, from 0% by weight to 4% by weight of indium, where the amounts add up to 100% by weight.
16. Solder alloys as per one or more of the preceding points, containing from 0.5% by weight to 7% by weight or from 0.2% by weight to 4% by weight or from 0.5% by weight to 3% by weight of indium.
17. Solder alloys as per one or more of the preceding points, containing from 0.3% by weight to 3% by weight or from 0.5% by weight to 1.5% by weight of tin.
18. Solder alloys as per one or more of the preceding points, containing from 0.3% by weight to 3% by weight, or from 0.3% by weight to 1.5% by weight or from 0.4% by weight to 1% by weight or from 0.5% by weight to 0.75% by weight of germanium.
19. Solder alloys as per one or more of the preceding points, containing from 0.1% by weight to 4% by weight or from 0.5% by weight to 2% by weight of titanium.
20. Solder alloys as per one or more of the preceding points, containing from 0.5% by weight to 15% by weight or from 0.5% by weight to 10% by weight of manganese.
21. Solder alloys as per one or more of the preceding points, containing from 0.1% by weight to 1% by weight of silicon.
22. Solder alloys as per one or more of the preceding points, containing from 0.1% by weight to 5% by weight or from 1% by weight to 4% by weight or from 0.3% by weight to 2% by weight of nickel.
23. Solder alloy, in particular as per any of the preceding points, consisting of from 5 to 15% by weight of gallium, wherein the remaining composition (balance to 100% by weight) contains Ag, Cu in a ratio of from 25:61 to 44:45.
24. Solder alloys as per one or more of the preceding points, wherein the weight ratio of copper to silver Cu/Ag is from 1 to 2.1.
25. Solder alloys as per one or more of the preceding points, wherein the weight ratio of copper to gallium Cu/Ga is from 4.5 to 7.5.
26. Use of the solder alloys as per one or more of the preceding points as vacuum hard solder.
27. Use of the solder alloys as per one or more of the preceding claims as solder in vacuum applications, sealing of or against vacuum, vacuum switching chambers, for soldering of contacts, soldering of switches, in the automobile industry, soldering of tools, soldering of cemented hard materials, soldering in the fields of refrigeration or air conditioning (HVAC), soldering in plant construction and special machine construction, soldering in domestic appliances, for example white goods, soldering in jewelry and combinations thereof.
28. A shaped object, containing a solder alloy as per one or more of the preceding points in contact with at least one substrate.
29. A shaped object as per point 28, wherein the substrate is selected from the group consisting of copper and copper alloys, nickel and nickel alloys, brass alloys, structural steel types (e.g. S235), stainless steel types (e.g. 1.4301/1.4306/1.4401/1.4404/1.4571) and nickel-plated, copper-plated or gilded ceramics and combinations thereof.
30. Process for producing shaped objects from solder alloys as per one or more of the preceding points, wherein the solder alloys are cold formed up to an achievable thickness decrease during cold rolling of greater than about 60%, or greater than about 80% and up to about 96% or about 99% or about 99.9%, without carrying out a heat treatment.
31. Process as per point 30, wherein the forming is carried out by rolling, forging, wire drawing or extrusion.
32. Process as per point 30 or 31, wherein a heat treatment is carried out in a further step and further cold forming is subsequently carried out.
33. Process as per point 32, wherein the temperature of the heat treatment is from 400° C. to 600° C. or from 400° C. to 550° C. or is carried out for a time of from 30 minutes to 300 minutes or from 60 minutes to 150 minutes.
34. Process for soldering substrates, wherein a solder alloy as per any of points 1 to 25 is used and the soldering temperature is in a range having a lower limit of 0.3*(TL-Ts)+Ts and an upper limit of TL+50 Kelvin, where TL is the liquidus temperature and Ts is the solidus temperature of the respective solder alloy.
35. Process as per point 34, wherein the substrate is selected from the group consisting of copper and copper alloys, nickel and nickel alloys, iron or iron alloys, brass alloys, structural steel types (e.g. S235), stainless steel types (e.g. 1.4301/1.4306/1.4401/1.4404/1.4571), cemented hard materials, cemented hard material composites, contact materials such as e.g. CuCr, AgSnO₂ and AgWC materials and nickel-plated, copper-plated, or gilded ceramics and combinations thereof.
36. Shaped object obtainable as per one of points 30 to 35.
37. Use as per point 26 or 27, shaped object as per any of points 28, 29 or 36 and process as per any of points 34 to 35, wherein an interdiffusion zone is formed between the solder and at least one substrate.
38. Use, process or shaped object as per point 37, wherein the substrate is iron or iron alloys or stainless steel such as stainless steel 1.4404.

### DETAILED DESCRIPTION OF THE INVENTION

The solder alloy contains from 20% by weight to 44% by weight of silver, from 5% by weight to 15% by weight of gallium and copper balanced to 100% by weight, where the constituents can contain unavoidable impurities.

The solder alloys contain from 41% by weight to 75% by weight or from 45 to 60% by weight of copper, from 20% by weight to 44% by weight of silver, or from 25 to 44% by weight or from 30 to 44% by weight of silver, and from 5% by weight to 15% by weight or from 6% by weight to 14% by weight of gallium, where the constituents add up to 100% by weight and can contain unavoidable impurities.

In a specific embodiment, the solder alloy can contain from 20% by weight to 44% by weight of silver, from 5% by weight to 15% by weight of gallium, from 0.1% by weight to 15% by weight or from 0.1% by weight to 10% by weight of further alloying elements selected from the group consisting of indium, tin, germanium, titanium, manganese, silicon, nickel and combinations thereof and copper as balance to 100% by weight, where the constituents add up to 100% by weight and can contain unavoidable impurities.

The solder alloys contain from 41% by weight to 75% by weight or from 45 to 60% by weight of copper, from 20% by weight to 44% by weight of silver, or from 25 to 44% by weight or from 30 to 44% by weight of silver, from 5% by weight to 15% by weight or from 6% by weight to 14% by weight of gallium, and also from 0.1% by weight to 15% by weight or from 0.1% by weight to from 10% by weight of further alloying elements selected from the group consisting of indium, tin, germanium, titanium, manganese, silicon, nickel and combinations thereof, where the constituents add up to 100% by weight and can contain unavoidable impurities.

In a further specific embodiment the solder alloy contains indium in combination with tin, titanium, manganese or combinations thereof.

The solder alloy can additionally contain from 0.5% by weight to 7% by weight of indium, from 0.3% by weight to 3% by weight of tin, from 0.3% by weight to 3% by weight of germanium or from 0.3% by weight to 1.5% by weight of germanium, from 0.1% by weight to 4% by weight of titanium, from 0.5% by weight to 15% by weight or else from 0.5% by weight to 10% by weight of manganese, from 0.1% by weight to 1% by weight of silicon, from 0.1% by weight to 5% by weight or from 1% by weight to 4% by weight of nickel or combinations thereof in the appropriate amounts, where the constituents add up to 100% and can contain unavoidable impurities.

The alloys can also contain a total of up to 0.15% by weight of tolerated, unavoidable impurities, e.g. lithium, sodium, potassium, rubidium, cesium, beryllium, magnesium, calcium, strontium, barium, antimony, selenium, tellurium, iron, zinc, silicon, phosphorus, sulfur, platinum, palladium, lead, gold, aluminum, tin, germanium, carbon, cadmium, scandium, lanthanum, cerium, praseodymium, neodymium, promethium, samarium, europium, yttrium, gadolinium, terbium, dysprosium, holmium, erbium, thulium, ytterbium, lutetium and oxygen. The content of carbon should be not greater than 0.005% by weight, and the content of cadmium, phosphorus, lead and zinc should each be not greater than 0.01% by weight.

The total content of lithium, sodium, potassium, rubidium, cesium, beryllium, magnesium, calcium, strontium, barium, antimony, selenium, tellurium and sulfur is, in particular, 0.01% by weight or less.

In a further embodiment, the alloy consists of from 48% by weight to 67% by weight of copper, from 20% by weight to 25% by weight of silver, from 5 to 15% by weight of gallium, from 0% by weight to 15% by weight of manganese, from 0% by weight to 3% by weight of indium, wherein the content of manganese is greater than 10% by weight when the gallium content is less than 10% by weight and the amounts add up to 100% by weight. Good results can also be achieved when the content of gallium is greater than 10% by weight, and when the manganese content is less than 10% by weight.

In a further embodiment the alloy consists of from 58% by weight to 65% by weight of copper, from 20% by weight to 25% by weight of silver, from 5 to 15% by weight of gallium, from 0% by weight to 15% by weight of manganese, from 0% by weight to 3% by weight of indium, wherein the content of manganese is greater than 10% by weight when the gallium content is less than 10% by weight and the amounts add up to 100% by weight. Good results can also be achieved when the content of gallium is greater than 10% by weight, and when the manganese content is less than 10% by weight.

It has surprisingly been found that even alloys having low silver contents of from 20% by weight to 25% by weight have the desired properties if the contents of gallium or manganese are above 10% by weight. In this case, good results can likewise be achieved using an indium content of from 1 to 3% by weight.

In a further embodiment, the alloy consists of from 41% by weight to 54% by weight of copper, from 38% by weight to 42% by weight of silver, from 8 to 12% by weight of gallium, from 0% by weight to 5% by weight of manganese, from 0% by weight to 4% by weight of indium, where the amounts add up to 100% by weight.

In a further embodiment, the alloy consists of from 41% by weight to 52% by weight of copper, from 38% by weight to 42% by weight of silver, from 5 to 9% by weight of gallium, from 7% by weight to 12% by weight of manganese, from 0% by weight to 4% by weight of indium, where the amounts add up to 100% by weight.

In a further embodiment the alloy consists of from 50% by weight to 64% by weight of copper, from 28% by weight to 34% by weight of silver, from 8 to 12% by weight of gallium, from 0% by weight to 5% by weight of manganese, from 0% by weight to 4% by weight of indium, where the amounts add up to 100% by weight.

In a further embodiment the alloy consists of from 45% by weight to 62% by weight of copper, from 28% by weight to 34% by weight of silver, from 5 to 9% by weight of gallium, from 7% by weight to 12% by weight of manganese, from 0% by weight to 4% by weight of indium, where the amounts add up to 100% by weight.

Particularly useful solder alloys comprise: (1) a solder alloy, consisting of 40% by weight of silver, 50% by weight of copper and 10% by weight of gallium; or (2) a solder alloy, consisting of 40% by weight of silver, 46.5% by weight of copper, 10% by weight of gallium, 3% by weight of indium and 0.5% by weight of tin; or (3) a solder alloy, consisting of from 5 to 15% by weight of gallium, with the remaining composition (balanced to 100% by weight) being Ag, Cu in a proportional ratio of from 25:61 to 44:45. The weight ratio of copper to silver Cu/Ag is generally from 1 to 2.1, the weight ratio of copper to gallium Cu/Ga is generally from 4.5 to 7.5.

The solder alloy can be obtained in any way known in the art and be poured into the desired mold using all methods known in the art. For example. the solder alloy can be in strip form, wire form, rod form, plate form, foil form, raw form, powder form, shot form, platelet form or paste form. The alloy can, for example, be produced by chill casting. To produce a more homogeneous microstructure, the use of continuous casting or an alloy granulator or alloy atomization is also possible.

Likewise, an alloy powder production step of this type can be followed by subsequent compaction, for example, continuous powder extrusion, also known under the name TEMCONEX®. Further processing of the powder by pressing, for example, cold isostatic pressing (CIP) with subsequent sintering and extrusion, is likewise possible.

The solder alloy can be hard soldered at a temperature in the range from about 750° C. to 900° C., or from about 780° C. to about 830° C., for a time which is sufficient to allow the solder alloy to melt onto a substrate which is, for example, formed by an iron-containing material, e.g. steel or stainless steel. Structural steel types (e.g. S235) and stainless steel types (e.g. 1.4301/1.4306/1.4401/1.4404/1.4571), for example, are likewise well suited. Use of the alloys of the present invention enables soldering to be carried out using a furnace, locally using a soldering lamp, using an induction heater, dipping into a solder or flux bath, by resistance heating, laser heating or infrared heating. Depending on the soldering process used, soldering can be carried out in an inert gas atmosphere, e.g. an argon atmosphere, or another type of protective atmosphere. At these temperatures, the solder alloy of the present invention melts and wets the iron-containing substrate material without difficulty, in order to be bonded without melting the iron-containing substrate material. When using the solder alloys, an interdiffusion zone in which the substrate material is partially dissolved is often formed. This is, for example, often observed in the case of iron alloys such as steels in combination with the solder alloys. Such an interdiffusion zone occurs during soldering and is advantageous and desirable as an active interaction between solder and substrate. In the case of silver-rich solders of the prior art, for example AgCu28 or Ag60Cu27In13, such an interdiffusion zone generally does not occur during soldering of stainless steels. The solder alloy of the present invention can be used, inter alia, to hard solder steel surfaces, in particular surfaces composed of stainless steel. Instead of a substrate of an iron-containing alloy, it is likewise possible to use copper or copper alloys, nickel or nickel alloys, brass alloys, cemented hard materials, cemented hard material composites, contact materials such as CuCr, AgSnO₂ and AgWC materials or nickel-plated/copper-plated/gilded ceramics.

The present patent application therefore also provides corresponding shaped objects.

The solder alloys are suitable, for example, for vacuum applications such as sealing of or against vacuum, in vacuum switching chambers, X-ray tubes or in cooler construction, and also for soldering contacts, in switches or the automobile industry. The solder alloys are also suitable for soldering of tools, for example in the soldering of cemented hard materials or soldering in the fields of refrigeration or air conditioning, in plant construction and special machine construction. Soldering in domestic appliances, for example white goods, or in jewelry is likewise possible.

An advantage of the solder alloys is their good cold deformability despite a high gallium concentration in the alloy. This property firstly improves the mechanical stability of the soldered bond. Secondly, the solder alloy can therefore be more easily formed by rolling, forging, wire drawing or extrusion, in particular in cold forming by rolling, forging or wire drawing, since it is possible to work up to an achievable thickness decrease in cold rolling of greater than about 60%, or greater than about 80% and up to about 96% or about 99% or about 99.9%, without a heat treatment such as an annealing heat treatment or recrystallization heat treatment. Subsequently, i.e. after cold forming of from about 60% to about 99.9%, a heat treatment can be carried out and renewed cold forming of from about 60% to about 99.9% can be carried out. Such a heat treatment can be carried out at temperatures of from 400° C. to 600° C., or from 400° C. to 550° C. The duration of the heat treatment can in general be from 30 minutes to 300 minutes, or from 60 minutes to 150 minutes, or from 90 minutes to 140 minutes. The heat treatment can be carried out under reduced pressure or in a protective gas such as argon or nitrogen or in a reducing atmosphere such as an N₂/H₂ mixture (e.g. N₂/H₂ 95/5, N₂/H₂ 80/20, N₂/H₂ 50/50) or hydrogen. When the solder alloys are used in an inert gas atmosphere, e.g. an argon atmosphere, it is not necessary to use any flux.

The solder alloys described can also be used on surfaces which have not been deoxidized or have been only incompletely deoxidized, i.e. surfaces with incomplete oxide removal. The solder alloys described wet these well and can be readily soldered. Thus, for example, it is also possible to solder chromium-containing stainless steels which have a natural layer of chromium(III) oxide on the surface, without the surface having to be modified by electropolishing or electroplating with gold, nickel, copper or combinations thereof.

Soldering using the solder alloys can be readily carried out in a particular temperature range whose upper limit is defined by TL+50 kelvin and whose lower limit is defined by 0.3*(TL−Ts)+Ts, where TL is the liquidus temperature and Ts is the solidus temperature of the respective solder alloy. One embodiment therefore also provides a process for soldering substrates, preferably substrates composed of steel, wherein the solder alloy is used and the soldering temperature is in a range having a lower limit of 0.3*(TL−Ts)+Ts and an upper limit of TL+50 kelvin, where TL is the liquidus temperature and Ts is the solidus temperature of the respective solder alloy.

### Examples

The alloys mentioned were obtained by chill casting of the corresponding alloy constituents. Melting was effected in an induction furnace. The size of the batches was 500 g of the solder alloy in each case. The alloys obtained were further processed by rolling and, for soldering stainless steel 1.4404, furnace-soldered at a temperature of 830° C. under reduced pressure onto a substrate of the same material (stainless steel 1.4404). Wetting was assessed visually. The cold deformability was determined by means of the decrease in thickness on rolling and the solidus and liquidus temperatures were determined by differential scanning calorimetry (DSC). In the case of the alloy having the composition CuAg40Ga10, the achievable thickness decrease on cold rolling without heat treatment was 96%, the solidus temperature was 724° C. and the liquidus temperature was 846° C.

| | Cu | Ag | Ga | Mn | In | Sn | Ge | Ti | Si | Ni | Cu/Ag | Cu/Ga | Ag/Ga | B | K | L |
|---|---|---|---|---|---|---|---|---|---|---|---|---|---|---|---|---|
| Example | | | | | | | | | | | | | | | | |
| 1 | 62.0 | 25 | 13 | | | | | | | | 2.5 | 4.8 | 1.92 | ++ | + | ++ |
| 2 | 60.0 | 25 | 5 | 10 | | | | | | | 2.4 | 12.0 | 5.00 | ++ | ++ | + |
| 3 | 57.0 | 25 | 5 | 13 | | | | | | | 2.3 | 11.4 | 5.00 | ++ | + | ++ |
| 4 | 55.0 | 30 | 5 | 10 | | | | | | | 1.8 | 11.0 | 6.00 | ++ | ++ | ++ |
| 5 | 60.0 | 30 | 5 | 5 | | | | | | | 2.0 | 12.0 | 6.00 | ++ | ++ | + |
| 6 | 57.0 | 30 | 5 | 5 | 3 | | | | | | 1.9 | 11.4 | 6.00 | ++ | ++ | ++ |
| 7 | 59.0 | 30 | 5 | 5 | | 1 | | | | | 2.0 | 11.8 | 6.00 | ++ | ++ | ++ |
| 8 | 59.8 | 30 | 10 | | | | | | 0.25 | | 2.0 | 6.0 | 3.00 | ++ | ++ | ++ |
| 9 | 59.5 | 30 | 10 | | | | | | 0.50 | | 2.0 | 6.0 | 3.00 | ++ | ++ | ++ |
| 10 | 55.0 | 35 | 10 | | | | | | | | 1.6 | 5.5 | 3.50 | ++ | ++ | ++ |
| 11 | 50.0 | 40 | 10 | | | | | | | | 1.3 | 5.0 | 4.00 | ++ | ++ | ++ |
| 12 | 48.0 | 42 | 10 | | | | | | | | 1.1 | 4.8 | 4.20 | ++ | ++ | ++ |
| 13 | 49.0 | 42 | 9 | | | | | | | | 1.2 | 5.4 | 4.67 | ++ | ++ | ++ |
| 14 | 51.0 | 41 | 8 | | | | | | | | 1.2 | 6.4 | 5.13 | ++ | ++ | ++ |
| 15 | 50.0 | 42 | 8 | | | | | | | | 1.2 | 6.3 | 5.25 | ++ | ++ | ++ |
| 16 | 52.0 | 38 | 10 | | | | | | | | 1.4 | 5.2 | 3.80 | ++ | ++ | ++ |
| 17 | 51.0 | 40 | 9 | | | | | | | | 1.3 | 5.7 | 4.44 | ++ | ++ | ++ |
| 18 | 51.0 | 38 | 11 | | | | | | | | 1.3 | 4.6 | 3.45 | ++ | ++ | ++ |
| 19 | 53.0 | 36 | 11 | | | | | | | | 1.5 | 4.8 | 3.27 | ++ | ++ | ++ |
| 20 | 47.0 | 40 | 10 | | 3 | | | | | | 1.2 | 4.7 | 4.00 | ++ | ++ | ++ |
| 21 | 46.5 | 40 | 10 | | 3 | 0.50 | | | | | 1.2 | 4.7 | 4.00 | ++ | ++ | ++ |
| 22 | 49.5 | 40 | 10 | | | | 0.50 | | | | 1.2 | 5.0 | 4.00 | ++ | ++ | ++ |
| 23 | 49.0 | 40 | 10 | | | 1 | | | | | 1.2 | 4.9 | 4.00 | ++ | ++ | ++ |
| 24 | 48.0 | 40 | 10 | | | | | | | 2 | 1.2 | 4.8 | 4.00 | ++ | ++ | ++ |
| 25 | 46.0 | 42 | 10 | | | | | | | 2 | 1.1 | 4.6 | 4.20 | ++ | ++ | ++ |
| 26 | 49.0 | 40 | 10 | | | | | 1 | | | 1.2 | 4.9 | 4.00 | ++ | ++ | ++ |
| 27 | 48.0 | 40 | 10 | | 1 | | | 1 | | | 1.2 | 4.8 | 4.00 | ++ | ++ | ++ |
| 28 | 45.0 | 40 | 5 | 10 | | | | | | | 1.1 | 9.0 | 8.00 | ++ | ++ | ++ |
| 29 | 50.0 | 40 | 5 | 5 | | | | | | | 1.3 | 10.0 | 8.00 | ++ | ++ | ++ |
| 30 | 47.0 | 40 | 5 | 5 | 3 | | | | | | 1.2 | 9.4 | 8.00 | ++ | ++ | ++ |
| 31 | 49.8 | 40 | 10 | | | | | | 0.25 | | 1.2 | 5.0 | 4.00 | ++ | ++ | ++ |
| 32 | 49.5 | 40 | 10 | | | | | | 0.50 | | 1.2 | 5.0 | 4.00 | ++ | ++ | ++ |
| 33 | 49.0 | 40 | 10 | | | | | 1 | | | 1.2 | 4.9 | 4.00 | ++ | ++ | ++ |
| 34 | 48.0 | 44 | 8 | | | | | | | | 1.1 | 6.0 | 5.50 | ++ | + | ++ |
| 35 | 58.0 | 20 | 5 | 15 | 2 | | | | | | 2.9 | 11.6 | 4.00 | ++ | ++ | ++ |
| 36 | 59.0 | 20 | 5 | 15 | 1 | | | | | | 3.0 | 11.8 | 4.00 | ++ | ++ | ++ |
| 37 | 62.0 | 20 | 12 | 5 | 1 | | | | | | 3.1 | 5.2 | 1.66 | ++ | ++ | + |
| 38 | 60.0 | 20 | 13 | 5 | 2 | | | | | | 3.0 | 4.6 | 1.54 | ++ | + | ++ |
| 39 | 64.0 | 20 | 13 | | 3 | | | | | | 3.2 | 4.9 | 1.53 | ++ | + | + |
| 40 | 65.0 | 20 | 15 | | | | | | | | 3.2 | 4.3 | 1.33 | ++ | + | + |
| 41 | 59.0 | 20 | 12 | 8 | 1 | | | | | | 3.0 | 4.9 | 1.67 | ++ | + | ++ |
| 42 | 58.5 | 22.5 | 5 | 13 | 1 | | | | | | 2.6 | 11.7 | 4.50 | ++ | ++ | ++ |
| 43 | 59.5 | 22.5 | 12 | 5 | 1 | | | | | | 2.6 | 45.0 | 1.88 | ++ | ++ | ++ |
| 44 | 41.0 | 43 | 5 | 10 | 1 | | | | | | 1.0 | 8.2 | 8.60 | ++ | ++ | ++ |
| 45 | 41.0 | 42 | 5 | 10 | 2 | | | | | | 1.0 | 8.2 | 8.40 | ++ | + | ++ |
| Comparative | | | | | | | | | | | | | | | | |
| example | | | | | | | | | | | | | | | | |
| 1 | 90.0 | 0 | 10 | | | | | | | | n.d. | 9.0 | 0.00 | ++ | ++ | ◯ |
| 2 | 82.0 | 0 | 18 | | | | | | | | n.d. | 4.6 | 0.00 | ++ | − | ◯ |
| 3 | 80.0 | 10 | 10 | | | | | | | | 8.0 | 8.0 | 1.00 | ++ | ++ | ◯ |
| 4 | 70.0 | 20 | 10 | | | | | | | | 3.5 | 7.0 | 2.00 | ++ | ++ | − |
| 5 | 68.0 | 30 | 2 | | | | | | | | 2.3 | 34.0 | 15.00 | − | ++ | − |
| 6 | 60.0 | 40 | | | | | | | | | 1.5 | n.d. | n.d. | ◯ | ++ | ◯ |
| 7 | 58.0 | 40 | 2 | | | | | | | | 1.5 | 29.0 | 20.00 | − | ++ | − |
| 8 | 45.0 | 40 | 15 | | | | | | | | 1.1 | 3.0 | 2.67 | ++ | − | ++ |
| 9 | 40.0 | 40 | 20 | | | | | | | | 1.0 | 2.0 | 2.00 | ++ | ◯ | ++ |
| 10 | 35.0 | 40 | 25 | | | | | | | | 0.9 | 1.4 | 1.60 | ++ | ◯ | ++ |
| 11 | 25.0 | 40 | 15 | 20 | | | | | | | 0.6 | 1.7 | 2.67 | ++ | ◯ | ++ |
| 12 | 35.0 | 50 | 15 | | | | | | | | 0.7 | 2.3 | 3.33 | ++ | ◯ | ++ |
| 13 | 48.0 | 50 | 2 | | | | | | | | 1.0 | 24.0 | 25.00 | − | ++ | + |
| 14 | 40.0 | 50 | 10 | | | | | | | | 0.8 | 4.0 | 5.00 | ++ | − | ++ |
| 15 | 35.0 | 55 | 10 | | | | | | | | 0.6 | 3.5 | 5.50 | ++ | − | ++ |
| 16 | 40.0 | 60 | | | | | | | | | 0.7 | n.d. | n.d. | ◯ | ++ | + |
| 17 | 30.0 | 60 | | | 10 | | | | | | 0.5 | n.d. | n.d. | ◯ | + | ++ |
| 18 | 30.0 | 60 | | | | 10 | | | | | 0.5 | n.d. | n.d. | − | + | ++ |
| 19 | 35.0 | 60 | | | | | 5 | | | | 0.6 | n.d. | n.d. | + | − | ++ |
| 20 | 15.0 | 60 | 25 | | | | | | | | 0.3 | 0.6 | 2.40 | ++ | ◯ | ++ |
| 21 | 25.0 | 60 | 15 | | | | | | | | 0.4 | 1.7 | 4.00 | ++ | ◯ | ++ |
| 22 | 25.0 | 65 | 10 | | | | | | | | 0.4 | 2.5 | 6.50 | ++ | ◯ | ++ |
| 23 | 20.0 | 70 | 10 | | | | | | | | 0.3 | 2.0 | 7.00 | ++ | ◯ | ++ |
| 24 | 28.0 | 70 | 2 | | | | | | | | 0.4 | 14.0 | 35.00 | − | ++ | ++ |
| 25 | 28.0 | 72 | | | | | | | | | 0.4 | n.d. | n.d. | ◯ | ++ | ++ |
| 26 | 60 | 20 | 20 | | | | | | | | 3 | 3 | 1 | ++ | − | + |
| 27 | 77 | 20 | 3 | | | | | | | | 3.9 | 25.7 | 6.66 | ++ | ++ | − |
| 28 | 64.5 | 20 | 16 | | | | | | 6 | | 3.2 | 4.0 | 1.25 | ++ | − | ++ |
| 29 | 58 | 20 | 16 | | | | 6 | | | | 2.9 | 3.6 | 1.25 | ++ | − | ◯ |
| 30 | 53 | 20 | 5 | 22 | | | | | | | 2.7 | 10.6 | 4 | + | − | ++ |
| 31 | 73 | 20 | 3 | 3 | 1 | | | | | | 3.7 | 24.3 | 6.66 | + | ++ | − |
| 32 | 60 | 20 | 10 | 10 | | 7 | | | | | 3 | 6 | 2 | ++ | − | ++ |
| 33 | 53 | 20 | 10 | 10 | 7 | | | | | | 2.7 | 5.3 | 2 | ++ | − | ++ |

Column B reports the wetting and flow behavior on stainless steels, K is the cold deformability and L is the soldering behavior at 830° C. The amounts of the alloy constituents are reported in percent by weight. The assessment of wetting and flow behavior, of the soldering behavior at 830° C. and the cold deformability are given the grades ++ very good, + good, o not good, − unacceptable. The abbreviation “n.d.” refers to values which cannot be determined.

1-21. (canceled)

22. A process for vacuum brazing of joints for use in vacuum switching chambers, the process comprising brazing of the joints using a brazing alloy comprising the following constituents: from 41% by weight to 75% by weight of copper; from 20% by weight to 44% by weight of silver; from 5% by weight to 15% by weight of gallium wherein the constituents have a carbon content that does not exceed 0.005 by weight, and wherein the content of cadmium, phosphorus, lead, and zinc of the brazing alloy does not exceed 0.01% by weight each.

23. The process of claim 22, wherein the brazing alloy contains from 25 to 40% by weight of silver.

24. The process of claim 22, wherein the brazing alloy contains from 45 to 60% by weight of copper.

25. The process of claim 22, wherein the brazing alloy contains from 6% by weight to 14% by weight of gallium.

26. The process of claim 22, wherein the silver and copper in the brazing alloy are present in a proportional ratio of from 25:61 to 44:45.

27. The process of claim 22, wherein the brazing alloy further comprises from 0.1% by weight to 15% by weight of one or more further alloy constituents selected from the group consisting of manganese, nickel, indium, tin, germanium, titanium and silicon.

28. The process of claim 27, wherein the one or more further alloy constituents are selected from the group consisting of from 0.5% by weight to 15% by weight of manganese, from 0.1% by weight to 5% by weight of nickel, from 0.5% by weight to 7% by weight of indium, from 0.3% by weight to 3% by weight of tin, from 0.3% by weight to 1.5% by weight of germanium, from 0.1% by weight to 4% by weight of titanium, and from 0.1% by weight to 1% by weight of silicon and combinations thereof.

29. A vacuum switching chamber comprising brazed joints formed by use of a brazing alloy comprising the following constituents: from 41% by weight to 75% by weight of copper; from 20% by weight to 44% by weight of silver; from 5% by weight to 15% by weight of gallium wherein the constituents have a carbon content that does not exceed 0.005 by weight, and wherein the content of cadmium, phosphorus, lead, and zinc of the brazing alloy does not exceed 0.01% by weight each.

30. A process for vacuum brazing of joints comprising brazing of the joints using a brazing alloy comprising the following constituents: from 41% by weight to 75% by weight of copper; from 20% by weight to 44% by weight of silver; from 5% by weight to 15% by weight of gallium, wherein the constituents have a carbon content that does not exceed 0.005 by weight, and wherein the content of cadmium, phosphorus, lead, and zinc of the brazing alloy does not exceed 0.01% by weight each.

31. A process for soldering parts that are used in vacuum applications, the process comprising using a solder alloy comprising the following constituents: from 41% by weight to 75% by weight of copper; from 20% by weight to 44% by weight of silver; from 5% by weight to 15% by weight of gallium, wherein the constituents have a carbon content that does not exceed 0.005 by weight, and wherein the content of cadmium, phosphorus, lead, and zinc of the brazing alloy does not exceed 0.01% by weight each.
